(19) United States
(12) Patent Application Publication
(10) Pub. No.: US 2007/0097905 A1
(43) Pub. Date: May 3, 2007

(54) Method for transmitting and receiving data in a multi-hop wireless mobile communication system

(75) Inventors: Kyung-Joo Suh, Suwon-si (KR); Ki-Young Han, Yongin-si (KR); Dong-Ho Cho, Seoul (KR); Ki-Ho Lee, Daejeon (KR); Soo-Yong Jeon, Daejeon (KR); Jong-Wuk Son, Uljin-gun (KR); Chi-Sung Bae, Andong-si (KR); Soon-Young Yoon, Seoul (KR); Young-Hoon Kwon, Seongnam-si (KR); Jae-Hee Cho, Seoul (KR)

Correspondence Address: THE FARRELL LAW FIRM, 333 EARLE OVINGTON BOULEVARD., SUITE 701, UNIONDALE, NY, 11553, US

(73) Assignee: Samsung Electronics Co., Ltd., Suwon-si (KR)

(21) Appl. No.: 11/589,646

(22) Filed: Oct. 30, 2006

(30) Foreign Application Priority Data
Oct. 28, 2005 (KR) 2005-102361

(51) Int. Cl. H04Q 7/00

(52) U.S. Cl. 370/328

(57) ABSTRACT

A method is provided for transmitting and receiving data in a multi-hop wireless mobile communication system having a first mobile station (MS), a second MS, a base transceiver station (BTS), and a relay BTS. The method includes allowing the first MS to directly communicate with the BTS, and allowing the second MS to communicate with the BTS by relay of the relay BTS; performing communication between the BTS and the first MS and communication between the relay BTS and the second MS using a first frame; and performing communication between the BTS and the relay BTS using a second frame.

### PRIORITY

This application claims the benefit under 35 U.S.C. § 119(a) of an application filed in the Korean Intellectual Property Office on Oct. 28, 2005 and assigned Serial No. 2005-102361, the contents of which are incorporated herein by reference.

### BACKGROUND OF THE INVENTION

1. Field of the Invention

The present invention relates generally to a wireless mobile communication system, and in particular, to a method for transmitting and receiving data in a wireless mobile communication system using a multi-hop scheme.

2. Description of the Related Art

Presently, wireless mobile communication systems have developed from the 3^{rd} Generation mobile communication system into the 4^{th} Generation mobile communication system. Research on the 4^{th} Generation mobile communication system is being conducted not only to provide a higher rate, but also to extend the wireless transmission range, i.e. the service area. A multi-hop scheme has been proposed for the extension of the service area. In the multi-hop scheme, a relay node designed at low cost for communication with the nodes located outside the cell coverage uses a method of relaying signals to the nodes located outside the cell coverage.

A Wideband Code Division Multiple Access (W-CDMA) system employs multi-hop technology in which a user node (UE) serves as a relay based on an Opportunity Driven Multiple Access/Time Division Duplexing (ODMA/TDD) scheme, thereby extending coverage of the cellular network. In ODMA/TDD system, when a UE located outside the cellular coverage desires to communicate with a Node B, a UE located in the intermediate route serves as a relay node.

FIG. 1 is a diagram illustrating a system configuration for performing multi-hop communication based on ODMA/TDD in the conventional W-CDMA communication system.

Referring to FIG. 1, a base station (or Node B) 100 can distinguish mobile stations (or UEs) 102 and 104 to which it can directly provide service, from mobile stations 106 to 112 located outside the cell coverage. Mobile stations 106 to 112 located outside the cell coverage communicate directly with the mobile station 102 or 104 located in the cell, or communicate with the base station 100 based on ODMA/TDD by a relay.

FIG. 2 is a diagram illustrating a frame structure used for multi-hop communication in the conventional W-CDMA communication system.

Referring to FIG. 2, a frame is composed of a plurality of slots, and among the slots, an ODMA Dedicated Channel (ODCH) and an ODMA Random Access Channel (ORACH) slots needed by a relay node to relay data are necessary. The ORACH, a contention-based channel, is used for transmitting a small amount of data, while the ODCH, a non-contention-based channel, is used for transmitting a large amount of data.

However, the ODCH and ORACH slots should occupy some of the general slots for relay in a fixed manner. This is because it is not possible to adaptively allocate the ODCH or the ORACH when the traffic load changes abruptly due to movement of a mobile station, or when the traffic change is considerable even in a short interval, like Internet service.

That is, when a more than required number of fixed ODCH and ORACH slots are allocated in the frame, resource waste occurs, and when a less than required number of the fixed ODCH and ORACH slots are allocated in the frame, time delay occurs during data transmission, making it impossible to satisfy Quality of Service (QoS) of the mobile station.

### SUMMARY OF THE INVENTION

It is, therefore, an object of the present invention to provide a new frame structure in a multi-hop wireless mobile communication system.

It is another object of the present invention to provide a new operation scenario for transmitting and receiving data in a multi-hop wireless mobile communication system.

According to one aspect of the present invention, there is provided a method for transmitting and receiving data in a multi-hop wireless mobile communication system having a first mobile station (MS), a second MS, a base transceiver station (BTS), and a relay BTS. The method includes allowing the first MS to directly communicate with the BTS, and allowing the second MS to communicate with the BTS by relay of the relay BTS; performing communication between the BTS and the first MS and communication between the relay BTS and the second MS using a first frame; and performing communication between the BTS and the relay BTS using a second frame.

According to another aspect of the present invention, there is provided a method for exchanging data with a mobile station (MS) by a relay base transceiver station (BTS) in a multi-hop wireless mobile communication system having a BTS and the relay BTS, the relay BTS relaying an MS signal transmitted to the BTS. The method includes making access to the BTS using a first frame; receiving a resource allocated from the BTS after authentication thereof; if the MS attempts an access to the relay BTS, notifying the BTS of the attempt using a second frame; upon receipt of a notification indicating completed authentication on the MS from the BTS, notifying the MS of the completed authentication using the first frame; and allocating some or all of resources allocated from the BTS to the MS, and exchanging data with the MS using the allocated resource.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a system configuration for performing multi-hop communication based on ODMA/TDD in the conventional W-CDMA communication system;

FIG. 2 is a diagram illustrating a frame structure used for multi-hop communication in the conventional W-CDMA communication system;

FIG. 3 is a diagram illustrating a configuration of a multi-hop wireless mobile communication system according to the present invention;

FIG. 4 is a diagram illustrating a multi-hop wireless mobile communication system using a Type-A frame according to the present invention;

FIG. 5 is a diagram illustrating a multi-hop wireless mobile communication system using a Type-B frame according to the present invention;

FIG. 6 is a diagram illustrating structures of a Type-A frame and a Type-B frame newly proposed in a multi-hop wireless mobile communication system according to the present invention;

FIG. 7 is a diagram illustrating a structure of data exchanged between a BTS and an MH-BTS in a multi-hop mobile communication system according to the present invention;

FIG. 8 is a diagram illustrating resource allocation information represented by MAP information in a multi-hop wireless mobile communication system according to the present invention;

FIGS. 9A and 9B are diagrams illustrating exemplary periodic frame allocation methods in a multi-hop wireless mobile communication system according to the present invention;

FIG. 10 is a diagram illustrating an exemplary random frame allocation method in a multi-hop wireless mobile communication system according to the present invention;

FIG. 11 is a signaling diagram illustrating signals exchanged between an MS, a BTS, and an MH-BTS in a multi-hop wireless mobile communication system according to the present invention; and

FIG. 12 is a signaling diagram illustrating information inserted in each individual frame depending on signals exchanged between an MS, a BTS, and an MH-BTS in a multi-hop wireless mobile communication system according to the present invention.

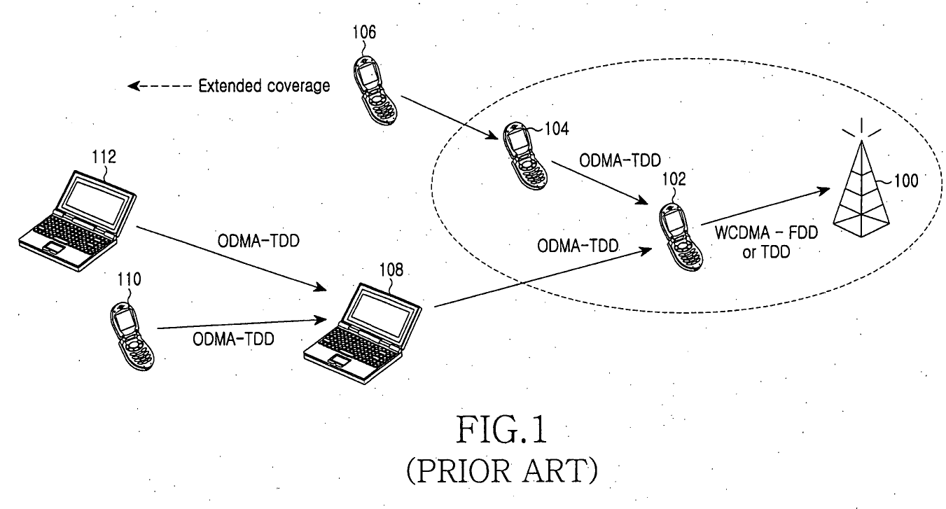

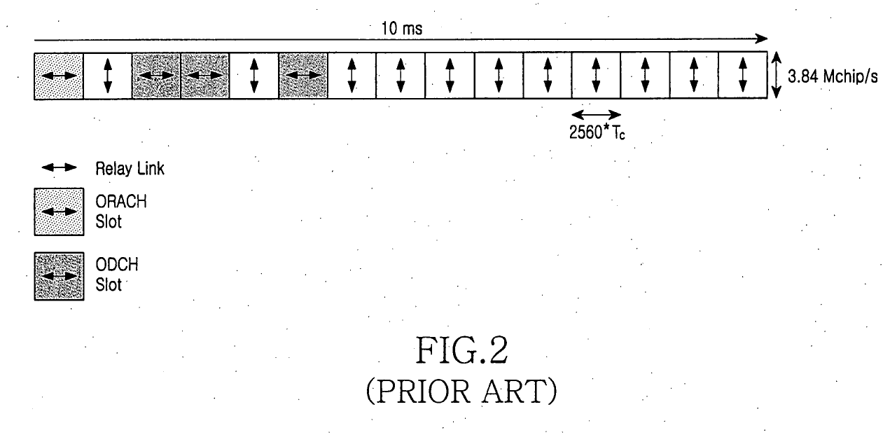

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides a new frame structure for efficiently using a multi-hop scheme in a multi-hop wireless mobile communication system, and presents an operation scenario for exchanging data between a base transceiver station (BTS), a mobile station (MS), and a relay BTS, or multi-hop BTS (“MH-BTS”), according to the new frame structure.

The present invention is applicable to a wireless mobile communication system using a multi-hop scheme (“multi-hop wireless mobile communication system”), and is preferably applicable to a communication system using an Orthogonal Frequency Division Multiple Access (OFDMA) scheme.

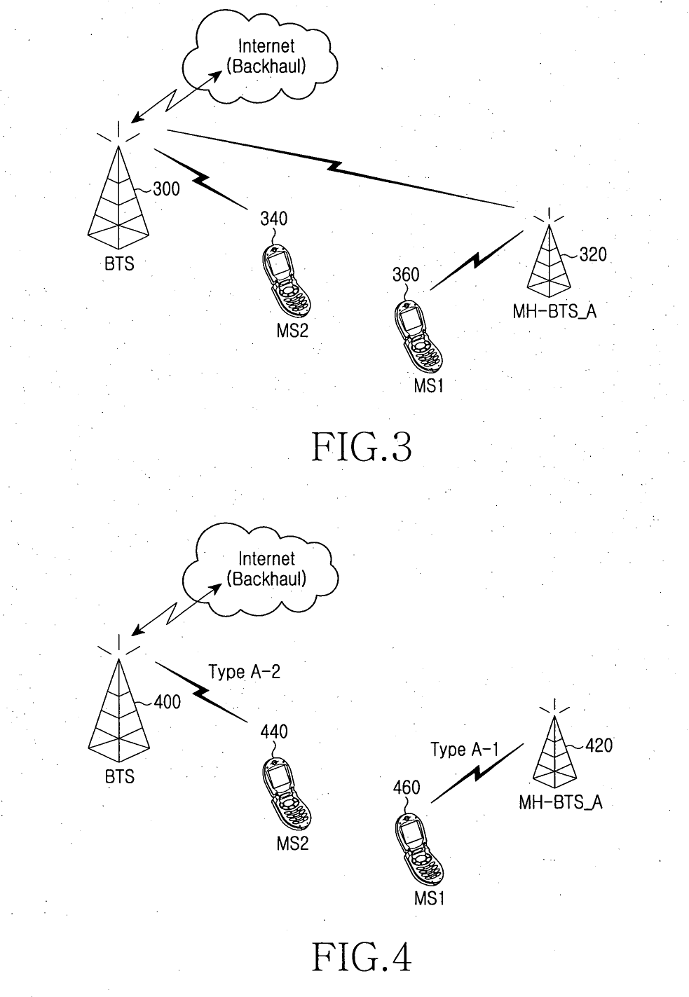

FIG. 3 is a diagram illustrating a configuration of a multi-hop wireless mobile communication system according to the present invention.

Referring to FIG. 3, a BTS 300 communicates directly with an MS 340, and an MH-BTS_A 320 communicates directly with an MS 360. The MH-BTS₁₃A 320 serves to relay the signals that the MS 360 transmits and receives to/from the BTS 300. The MH-BTS_A 320 can either move or be fixed.

In the communication system where only the BTS and MS exist, when the MH-BTS is added, the system takes into consideration not only the resources for data exchange between the BTS and the MS, but also the resources for delay, i.e. wireless resources allocated for data exchange between the MH-BTS and the MS, and wireless resources allocated for data exchange between the MH-BTS and the BTS.

The present invention uses a Time Division Duplexing (TDD) technique that time-shares all wireless resources. Accordingly, the present invention newly proposes a Type-A frame for data exchange between the BTS/MH-BTS and the MS that communicates directly with the BTS/MH-BTS, and a Type-B frame for data exchange between the BTS and the MH-BTS. A detailed description of the Type-A and Type-B frame structures will be made with reference to FIG. 6.

FIG. 4 is a diagram illustrating a multi-hop wireless mobile communication system using a Type-A frame according to the present invention.

Referring to FIG. 4, while a BTS 400 provides a service to an MS2 440 in its cell using a Type A-2 frame, an MH-BTS_A 420 also provides a service to an MS1 460 in its cell using a Type A-1 frame. The Type A-1 and the Type A-2 are different names used for distinguishing channels, and both of them have the form of Type A.

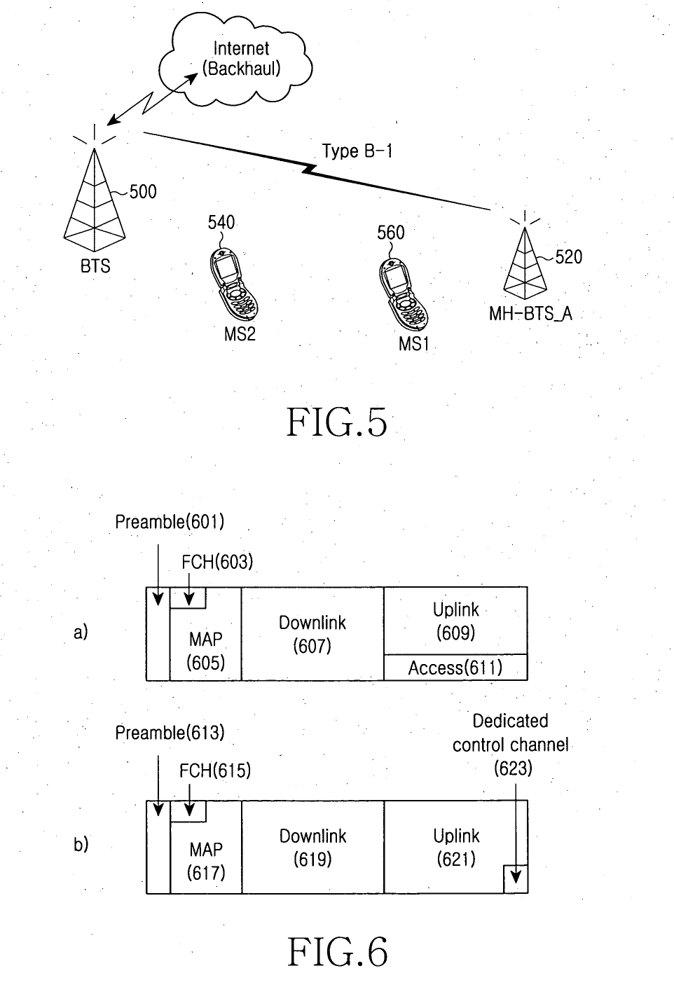

FIG. 5 is a diagram illustrating a multi-hop wireless mobile communication system using a Type-B frame according to the present invention.

Referring to FIG. 5, the Type-B frame is used for data communication between a BTS 500 and an MH-BTS_A 520. The BTS 500 and the MH-BTS_A 520 cannot provide a communication service to MSs 540 and 560 while communicating with each other using the Type-B frame.

Because the Type-A and Type-B frames are time-divided as described with reference to FIGS. 4 and 5, if the Type-A frame is used at a specified time, the Type-B frame cannot be used at the same time. On the contrary, if the Type-B frame is used at a specified time, the Type-A frame cannot be used at the same time. In addition, an entity allocating resources to an MH-BTS is a BTS, and the MH-BTS can send a resource allocation request to the BTS, reallocate resources to specific MSs using the resources allocated from the BTS, and relay signals using the reallocated resources.

The BTS selects one of the Type-A frame and the Type-B frame depending on traffic distribution. For example, if there is a large amount of data that the BTS exchanges with the MH-BTS, the BTS increases a frequency of use of the Type-B frame, and if there is a large amount of data that the BTS exchanges with an MS located in its own cell, the BTS increases a frequency of use of the Type-A frame.

FIG. 6 is a diagram illustrating structures of a Type-A frame and a Type-B frame newly proposed in a multi-hop wireless mobile communication system according to the present invention.

Referring to FIG. 6, a Type-A frame includes a preamble region 601, a Frame Control Header (FCH) region 603, a MAP region 605 including resource allocation information, a downlink (DL) region 607 where downlink data is allocated, an uplink (UL) region 609 where uplink data is allocated, and an access region 611. Similarly to the Type-A frame, a Type-B frame also includes a preamble region 613, an FCH region 615, a MAP region 617, a downlink region 619, and an uplink region 621. The only difference is that the Type-B frame includes a dedicated control channel region 623 instead of the access region 611 of the Type-A frame. A description will now be made of the scenarios where the Type-A frame and the Type-B frame are used.

First, it is assumed that a BTS communicates with an MS located in its own cell using the Type-A frame.

If the BTS maps its own BTS ID to the preamble region 601 and then transmits the signal to an MS, the MS can perform frame synchronization acquisition and channel estimation by receiving the preamble.

The FCH region 603 includes therein size information indicating a percentage of the MAP region 605 in the frame, Modulation and Coding Scheme (MCS) level information, an identifier for frame type identification, and information indicating the time the Type-A frame is to be used next. The information on the time the Type-A frame is to be used can include offset information corresponding to a difference between a frame index where the BTS currently uses the Type-A frame and a frame index where the BTS will next use the Type-A frame. If the current frame index is 3 and the offset value is 2, the BTS previously notifies the MS that it will use the Type-A frame in the next frame, i.e. a frame with frame index=5.

The MAP region 605 includes therein uplink/downlink resource allocation information, and the downlink region 607 and the uplink region 609 each include therein data and control information exchanged with the MS.

The access region 611 is used by an MS or an MH-BTS to randomly access the BTS.

Next, it is assumed that an MH-BTS communicates with an MS located in its own cell using the Type-A frame.

If the MH-BTS maps its own MH-BTS ID to the preamble region 601 and then transmits the signal to an MS, the MS can perform frame synchronization acquisition and channel estimation by receiving the preamble.

The FCH region 603 includes therein size information indicating a percentage of the MAP region 605 in the frame, MCS level information, an identifier for frame type identification, and information indicating the time the Type-A frame is to be used next, i.e. an offset value.

The MAP region 605 includes therein uplink/downlink resource allocation information, and the downlink region 607 and the uplink region 609 each include therein data and control information exchanged with the MS.

The access region 611 is used by an MS to randomly access the MH-BTS.

A description will now be made of a scenario where the BTS and the MH-BTS use the Type-B frame.

When the BTS and the MH-BTS use the Type-B frame, an ID of the BTS is mapped to the preamble region 613, and the MS can acquire synchronization with a tracking mode or an initial mode and perform channel estimation using the preamble.

The FCH region 615 includes therein size information indicating a percentage of the MAP region 617 in the frame, MCS level information, an identifier for frame type identification, and information indicating the time the Type-B frame is to be used next, i.e. an offset value.

The MAP region 617 includes therein uplink/downlink resource allocation information, and the downlink region 619 and the uplink region 621 each include therein data and control information exchanged between the BTS and the MH-BTS.

The dedicated control channel region 623 is used by the MH-BTS to request resource allocation. The dedicated control channel region 623 includes Acknowledge (ACK)/Negative-Acknowledge (NACK) information, and is used by the MH-BTS to transmit fast feedback-required control information to the BTS.

Because the signals exchanged between the BTS and the MH-BTS include data for a plurality of MSs, the BTS and the MH-BTS can perform efficient data exchange by aggregating data of the same type and distinguishing the data with a relay header.

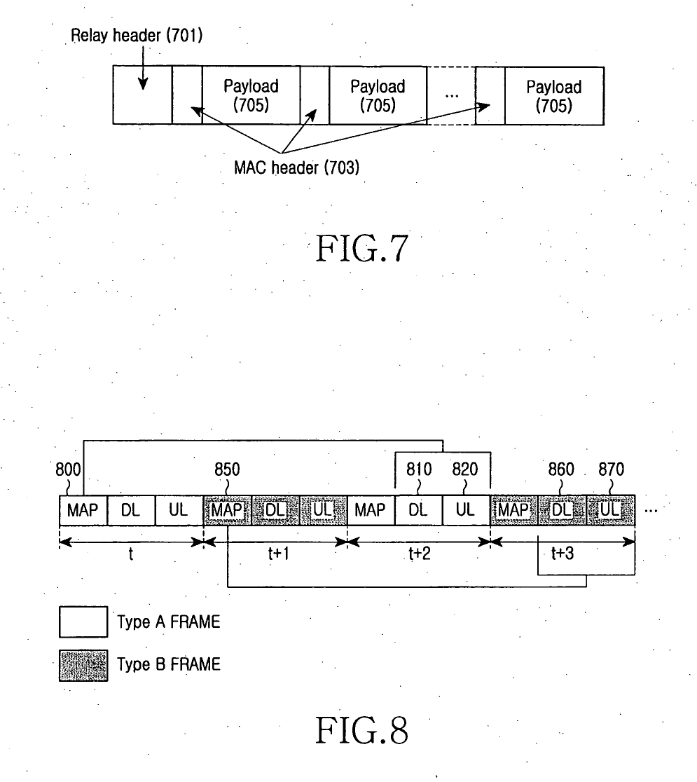

FIG. 7 is a diagram illustrating a structure of data exchanged between a BTS and an MH-BTS in a multi-hop mobile communication system according to the present invention.

Referring to FIG. 7, the data exchanged between the BTS and the MH-BTS includes a relay header region 701, a payload region 705, and a Medium Access Control (MAC) header region 703 for distinguishing each payload.

The relay header region 701 includes message type information, MH-BTS ID information, and total message length information. The MH-BTS ID information is used by the BTS to determine with which MH-BTS the corresponding data is associated. The message type information is used to determine to which message (for example, access, authentication, etc.) the transmission/reception information corresponds. The total length information is used to indicate an end of the message.

The MAC header region 703 includes destination information and length information of a payload, and allows the BTS and the MH-BTS to decode the MAC header and determine with which MS the corresponding payload is associated.

The resource allocation information included in the MAC region 605 or 617 shown in FIG. 6 represents resource allocation information corresponding to the next symbol time frame. A description thereof will be made with reference to the diagram of FIG. 8, which illustrates resource allocation information represented by MAP information in a multi-hop wireless mobile communication system according to an embodiment of the present invention.

Referring to FIG. 8, in a time interval ‘t’, a MAP region 800 of a Type-A frame includes resource allocation information for a downlink 810 and an uplink 820 of the Type-A frame in a time interval ‘t+2’ where the next Type-A frame is used. In addition, in a time interval ‘t+1’, a MAP region 850 of a Type-B frame includes resource allocation information for a downlink 860 and an uplink 870 of the Type-B frame in a time interval ‘t+3’ where the next Type-B frame is used.

A description will now be made of a method in which the BTS allocates the Type-A frame and the Type-B frame.

The frame allocation method is provided on the assumption that when the BTS and the MH-BTS perform communication using the Type-B frame, they do not use the Type-A frame for communication with the MS, and when the BTS or the MH-BTS communicates with the MS using the Type-A frame, it does not use the Type-B frame.

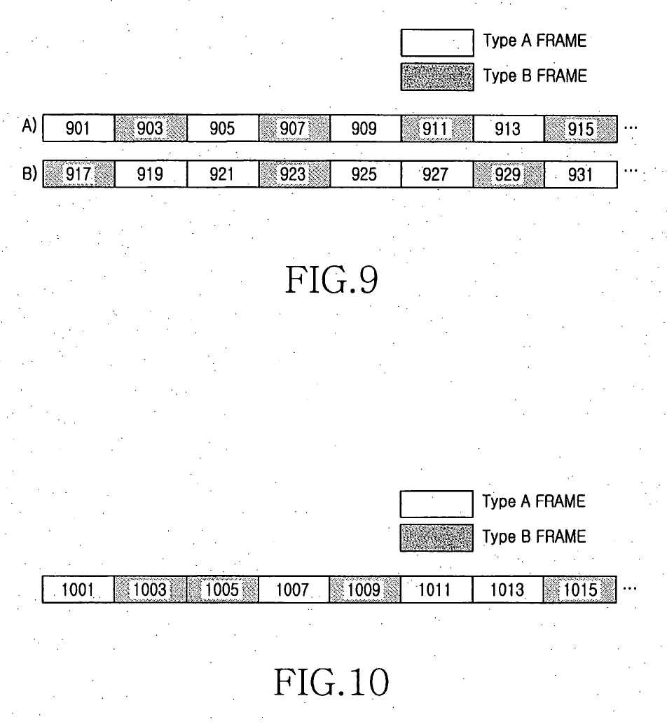

FIGS. 9A and 9B are diagrams illustrating exemplary periodic frame allocation methods in a multi-hop wireless mobile communication system according to the present invention.

Referring to FIGS. 9A and 9B, a BTS inserts Type-B frame use period information in an FCH in the form of an offset. FIG. 9A illustrates an exemplary frame allocation method where the Type-A frame and the Type-B frame are alternately used one by one, and FIG. 9B illustrates an exemplary frame allocation method where the Type-B frame is used at periods of 3 frames. In the case of FIG. 9A, an offset value is set to ‘2’ in the FCH of the Type-B frame, and in the case of FIG. 9B, an offset value is set to ‘3’ in the FCH of the Type-B frame. If it is provided that the system uses a frame having a specific type at a specific period, the offset value is specified in an FCH of an initial specific-type frame only once, and may not be specified in an FCH of the next frame. That is, the offset value is set to ‘1’ only in the FCHs of a Type-A frame 901 and a Type-B frame 903 of FIG. 9A, and no separate offset value can be specified in FCHs of the next frames 905 to 915. However, if there is a situation where the offset value in the frames should change, the offset value can be re-specified together with an indicator indicating the offset change.

Table 1 below shows exemplary information inserted in an FCH in each of the frames of FIGS. 9A and 9B.

TABLE 1

| | |
|---|---|
| For frames of FIG. 9A | For frames of FIG. 9B |

| | Information | | Information |
|---|---|---|---|
| Frame # | inserted in FCH | Frame # | inserted in FCH |
| 901 | F_type: A | 917 | F_type: B |
| | Offset: 2 | | Offset: 3 |
| 903 | F_type: B | 919 | F_type: A |
| | Offset: 2 | | Offset: 1 |
| 905 | F_type: A | 921 | F_type: A |
| | Offset: 2 (option) | | Offset: 2 |
| 907 | F_type: B | 923 | F_type: B |
| | Offset: 2 (option) | | Offset: 3 |
| 909 | F_type: A | 925 | F_type: A |
| | Offset: 2 (option) | | Offset: 1 |
| 911 | F_type: B | 927 | F_type: A |
| | Offset: 2 (option) | | Offset: 2 |
| 913 | F_type: A | 929 | F_type: B |
| | Offset: 2 (option) | | Offset: 3 |
| 915 | F_type: B | 931 | F_type: A |
| | Offset: 2 (option) | | Offset: 1 |

In Table 1, F_type is used for distinguishing between a Type-A frame and a Type-B frame, and an Offset value includes the information indicating in which frame following the current frame a frame of the same type is to be used. For example, information inserted in an FCH of the frame 901 indicates that the current frame is a Type-A frame, and the Type-A frame will be used again in the second frame.

FIG. 10 is a diagram illustrating an exemplary random frame allocation method in a multi-hop wireless moble communication system according to the present invention.

Referring to FIG. 10, compared with the periodic frame allocation method,a random frame allocation method is advantageous in terms of resource allocation efficiency, as it can dynamically consider resource allocation. A BTS, when it randomly allocates frames, inserts an offset value in an FCH of every frame to inform the MH-BTS when the same frame will be used again.

Table 2 below shows exemplary information inserted in an FCH of the frame of FIG. 10.

TABLE2

| Frame # | Information inserted in FCH |
|---|---|
| 1001 | F_type: A |
| | Offset: 3 |
| 1003 | F_type: B |
| | Offset: 1 |
| 1005 | F_type: B |
| | Offset: 2 |
| 1007 | F_type: A |
| | Offset: 2 |
| 1009 | F_type: B |
| | Offset: 3 |
| 1011 | F_type: A |
| | Offset: 1 |
| 1013 | F_type: A |
| | Offset: 2 |
| 1015 | F_type: B |
| | Offset: 4 |

When there is relay traffic, i.e. when there is data that the BTS will transmit to the MH-BTS, or when the MH-BTS sends a request for uplink resource allocation to the BTS, the BTS appropriately determines an offset value such that it can rapidly use the Type-B frame. However, if there is no relay traffic, the BTS decreases a frequency of use of the Type-B frame by multiplying an offset value inserted in an FCH of the Type-B frame by a predetermined integer.

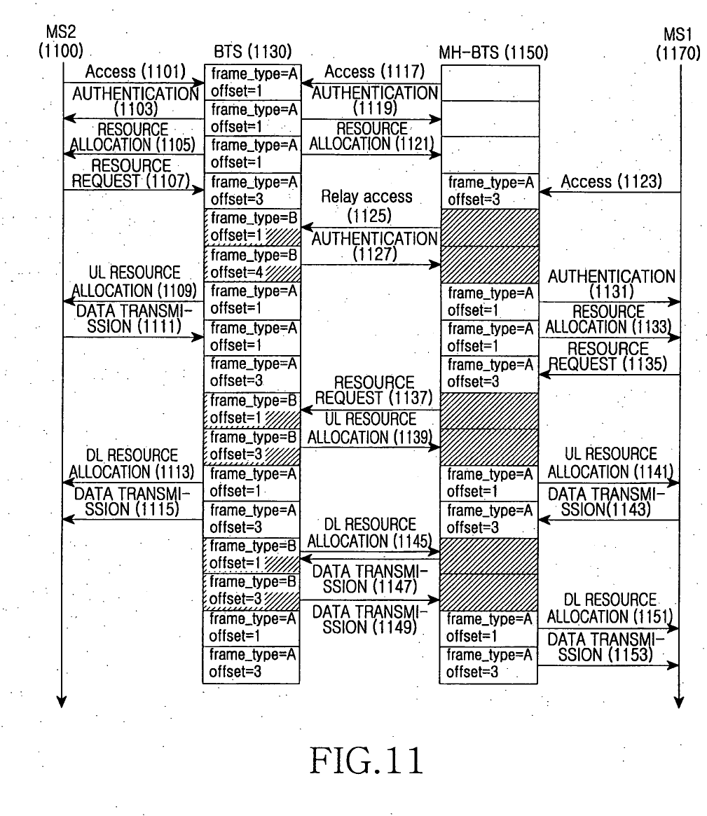

FIG. 11 is a signaling diagram illustrating signals exchanged between an MS, a BTS, and an MH-BTS in a multi-hop wireless mobile communication system according to the present invention.

Referring to FIG. 11, an MS2 1100 and an MH-BTS 1150 perform random access to a BTS 1130 through an access channel of a Type-A frame (Steps 1101 and 1117). Thereafter, the BTS 1130 performs authentication on the MS2 1100 and the MH-BTS 1150 in the Type-A frame (Steps 1103 and 1119), and allocates basic resources to the authenticated MS2 1100 and MH-BTS 1150 (Steps 1105 and 1121). If even the MH-BTS 1150 performs initial network entry to the BTS 1130, it uses the Type-A frame, and after completion of the initial network entry, performs communication with the BTS 1130 using only the Type-B frame.

The MS2 1100 requests the resources necessary for data exchange using the basic resources allocated from the BTS 1130 (Step 1107). The MH-BTS 1150 recognizes access attempt from an MS1 1170 connected thereto in one hop (Step 1123). Upon recognizing the access attempt of the MS1 1170, the MH-BTS 1150 relays access information of the MS1 1170 at the time the BTS 1130 uses the Type-B frame (Step 1125). In the next Type-B frame, the BTS 1130 completes authentication on the MS1 1170 to the MH-BTS 1150 (Step 1127). The MH-BTS 1150 provides authentication-completed information to the MS1 1170 (Step 1131), allocates basic resources to the MS1 1170 (Step 1133), and receives a required-resource allocation request from the MS1 1170 (Step 1135).

Upon receipt of the required-resource allocation request from the MS1 1170, the MH-BTS 1150 sends a required-resource allocation request to the BTS 1130 using the Type-B frame (Step 1137), and is allocated uplink resources from the BTS 1130 (Step 1139). The MH-BTS 1150 allocates some or all of its allocated uplink resources to the MS1 1170 (Step 1141), and receives data from the MS1 1170 (Step 1143). The non-described steps include steps in which the BTS 1130 or the MH-BTS 1150 allocates wireless resources to the MSs 1100 and 1170 and receives data therefrom, and steps in which resource allocation request, resource allocation, and data exchange are performed between the BTS 1130 and the MH-BTS 1150. These steps are similar to the steps described above, so a description thereof will be omitted.

As described above, signal exchange between the BTS 1130 and the MS2 1100 and signal exchange between the MH-BTS 1150 and the MS1 1170 are performed using the Type-A frame, and signal exchange between the BTS 1130 and the MH-BTS 1150 is performed using the Type-B frame. Exchange of control information and data between the BTS 1130 and the MH-BTS 1150 is achieved based on a message in the Type-B frame. Therefore, the BTS 1130 and the MH-BTS 1150 can distinguish between a source MS and a target MS according to MAC header information of received data. For example, in step 1125 of FIG. 11, the BTS 1130 can recognize that the corresponding access is an access from the MS1 1170, based on the MAC header information of a relay access message received from the MH-BTS 1150.

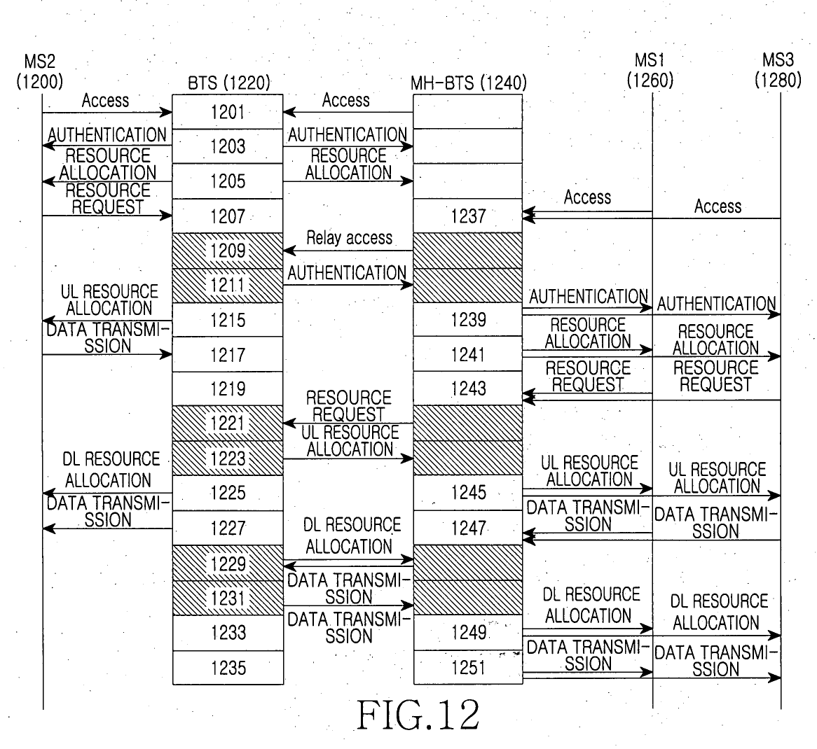

FIG. 12 is a signaling diagram illustrating information inserted in each individual frame depending on signals exchanged between an MS, a BTS, and an MH-BTS in a multi-hop wireless mobile communication system according to the present invention.

Referring to FIG. 12, an MS2 1200 and an MH-BTS 1240 are connected to a BTS 1220 in one hop, and an MS1 1260 and an MS3 1280 are connected to the BTS 1220 in two hops via the MH-BTS 1240. Signal exchange between the MSs 1200, 1260 and 1280, and the BTS 1220 or the MH-BTS 1240 is the same as that described in FIG. 11, so a detailed description thereof will be omitted herein. The information included in each individual frame is shown in Table 3 below.

TABLE 3

| Frame | | | | | | |
|---|---|---|---|---|---|---|
| # | Preamble | FCH | MAP | DL | UL | Access |
| 1201 | BTS_ID: | F_type: | — | — | — | Access |
| | B1 | A | | | | information |
| | | Offset: 1 | | | | of MS2 and |
| | | | | | | access |
| | | | | | | information |
| | | | | | | of MH-BTS |
| 1203 | BTS_ID: | F_type: | — | Authentication | — | — |
| | B1 | A | | information | | |
| | | Offset: 1 | | for MS2 and | | |
| | | | | authentication | | |
| | | | | information | | |
| | | | | for MH-BTS | | |
| 1205 | BTS_ID: | F_type: | Location | — | — | — |
| | B1 | A | information | | | |
| | | Offset: 1 | of UL | | | |
| | | | resource | | | |
| | | | allocated to | | | |
| | | | MS2 and | | | |
| | | | Location | | | |
| | | | information | | | |
| | | | of UL | | | |
| | | | resource | | | |
| | | | allocated to | | | |
| | | | MH-BTS | | | |
| 1207 | BTS_ID: | F_type: | — | — | Resource | — |
| | B1 | A | | | request | |
| | | Offset: 3 | | | information | |
| | | | | | of MS2 | |
| 1209 | BTS_ID: | F_type: | — | — | Access | |
| | B1 | B | | | information | |
| | | Offset: 1 | | | of MS1 and | |
| | | | | | MS3 | |
| 1211 | BTS_ID: | F_type: | — | Authentication | — | |
| | B1 | B | | information | | |
| | | Offset: 4 | | for MS1 and | | |
| | | | | MS3 | | |
| 1215 | BTS_ID: | F_type: | Location | — | — | — |
| | B1 | A | information | | | |
| | | Offset: 1 | of UL | | | |
| | | | resource | | | |
| | | | allocated to | | | |
| | | | MS2 | | | |
| 1217 | BTS_ID: | F_type: | — | — | UL data of | — |
| | B1 | A | | | MS2 | |
| | | Offset: 1 | | | | |
| 1221 | BTS_ID: | F_type: | — | — | Resource | |
| | B1 | B | | | request | |
| | | Offset: 1 | | | information | |
| | | | | | of MS1 and | |
| | | | | | MS3 | |
| 1223 | BTS_ID: | F_type: | Location | — | — | |
| | B1 | B | information | | | |
| | | Offset: 3 | of UL | | | |
| | | | resource | | | |
| | | | allocated to | | | |
| | | | MS1 and | | | |
| | | | MS3 | | | |
| 1225 | BTS_ID: | F_type: | Location | — | — | — |
| | B1 | A | information | | | |
| | | Offset: 1 | of DL | | | |
| | | | resource | | | |
| | | | allocated to | | | |
| | | | MS2 | | | |
| 1227 | BTS_ID: | F_type: | — | DL data to | — | — |
| | B1 | A | | MS2 | | |
| | | Offset: 3 | | | | |
| 1229 | BTS_ID: | F_type: | Location | — | UL data of | |
| | B1 | B | information | | MS1 and | |
| | | Offset: 1 | of UL | | MS3 | |
| | | | resource | | | |
| | | | allocated to | | | |
| | | | MS1 and | | | |
| | | | MS3 | | | |
| 1231 | BTS_ID: | F_type: | — | UL data to | — | |
| | B1 | B | | MS1 andMS3 | | |
| | | Offset: 4 | | | | |
| 1237 | MH- | F_type: | — | — | — | Access |
| | BTS_ID: | A | | | | information |
| | M1 | Offset: 3 | | | | of MS1 and |
| | | | | | | access |
| | | | | | | information |
| | | | | | | ofMH-BTS |
| 1239 | MH- | F_type: | — | Authentication | — | — |
| | BTS_ID: | A | | information | | |
| | M1 | Offset: 1 | | for MS1 and | | |
| | | | | authentication | | |
| | | | | information | | |
| | | | | for MS3 | | |
| 1241 | MH- | F_type: | Location | — | — | — |
| | BTS_ID: | A | information | | | |
| | M1 | Offset: 1 | of resource | | | |
| | | | allocated to | | | |
| | | | MS1 and | | | |
| | | | location | | | |
| | | | information | | | |
| | | | of resource | | | |
| | | | allocated to | | | |
| | | | MS3 | | | |
| 1243 | MH- | F_type: | — | — | Resource | — |
| | BTS_ID: | A | | | request | |
| | M1 | Offset: 3 | | | information | |
| | | | | | of MS1 and | |
| | | | | | resource | |
| | | | | | request | |
| | | | | | information | |
| | | | | | ofMS3 | |
| 1245 | MH- | F_type: | Location | — | — | — |
| | BTS_ID: | A | information | | | |
| | M1 | Offset: 1 | of UL | | | |
| | | | resource | | | |
| | | | allocated to | | | |
| | | | MS1 and | | | |
| | | | location | | | |
| | | | information | | | |
| | | | of UL | | | |
| | | | resource | | | |
| | | | allocated to | | | |
| | | | MS3 | | | |
| 1247 | MH- | F_type: | — | — | UL data of | — |
| | BTS_ID: | A | | | MS1 and | |
| | M1 | Offset: 3 | | | UL data of | |
| | | | | | MS3 | |
| 1249 | MH- | F_type: | Location | — | — | — |
| | BTS_ID: | A | information | | | |
| | M1 | Offset: 1 | of DL | | | |
| | | | resource | | | |
| | | | allocated to | | | |
| | | | MS1 and | | | |
| | | | location | | | |
| | | | information | | | |
| | | | of DL | | | |
| | | | resource | | | |
| | | | allocated to | | | |
| | | | MS3 | | | |
| 1251 | MH- | F_type: | — | DL data to | — | — |
| | BTS_ID: | A | | MS1 and DL | | |
| | M1 | Offset: 1 | | data to MS3 | | |

Table 3 shows information and data included in each region of the frame structure of FIG. 6. Herein, an ID of a BTS is denoted by B1, and an ID of an MH-BTS is denoted by M1.

As can be understood from the foregoing description, the present invention provides new frames and an operation method thereof so as to allow a BTS and a relay BTS (MH-BTS) serving as a relay to simultaneously operate in a multi-hop wireless mobile communication system, thereby contributing to improvement in wireless resource efficiency. In addition, because a data exchange method between the BTS and the MS is equal to a data exchange method between the BTS and the relay BTS, the new system can reduce its system complexity compared with other systems having a relay function.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting and receiving data in a multi-hop wireless mobile communication system having a first mobile station (MS), a second MS, a base transceiver station (BTS), and a relay BTS, the method comprising the steps of:
allowing the first MS to directly communicate with the BTS, and allowing the second MS to communicate with the BTS by relay of the relay BTS;
performing communication between the BTS and the first MS and communication between the relay BTS and the second MS using a first frame; and
performing communication between the BTS and the relay BTS using a second frame.

2. The method of claim 1, wherein the first frame and the second frame are time-divided.

3. The method of claim 2, wherein the first frame includes at least one of a preamble region for synchronization and channel estimation, a frame control header (FCH) region including an offset value, a MAP region including information on a location where data is allocated and a size thereof, a region where downlink data is allocated, a region where uplink data is allocated, and an access channel region that the first MS or the relay BTS can randomly access.

4. The method of claim 3, wherein the offset value indicates in which frame following the current frame the first frame is to be used again.

5. The method of claim 3, wherein the FCH region includes frame type information indicating the first frame.

6. The method of claim 2, wherein the second frame includes at least one of a preamble region for synchronization and channel estimation, an FCH region including an offset value, a MAP region including information on a location where data is allocated and a size thereof, a region where downlink data is allocated, a region where uplink data is allocated, and a dedicated control channel region where a control signal exchanged between the relay BTS and the BTS through a dedicated channel.

7. The method of claim 6, wherein the offset value indicates in which frame following the current frame the second frame is to be used again.

8. The method of claim 6, wherein the FCH region includes frame type information indicating the second frame.

9. The method of claim 1, wherein a frequency of use of the first frame and the second frame is adaptively determined according to an amount of traffic to be exchanged between the BTS and the relay BTS.

10. The method of claim 1, wherein data exchanged between the BTS and the relay BTS has a relay header including type information indicating a type of exchanged information, an identifier of the relay BTS, and total data length information.

11. The method of claim 1, wherein data exchanged between the BTS and the relay BTS has a medium access control (MAC) header including information used for distinguishing data of a plurality of MSs.

12. A method for exchanging data with a mobile station (MS) by a relay base transceiver station (BTS) in a multi-hop wireless mobile communication system having a BTS and the relay BTS, the relay BTS relaying an MS signal transmitted to the BTS, the method comprising the steps of:
making access to the BTS using a first frame;
receiving a resource allocated from the BTS after authentication thereof;
if the MS attempts an access to the relay BTS, notifying the BTS of the attempt using a second frame;
upon receipt of a notification indicating completed authentication on the MS from the BTS, notifying the MS of the completed authentication using the first frame; and
allocating some or all of resources allocated from the BTS to the MS, and exchanging data with the MS using the allocated resource.

13. The method of claim 12, wherein the relay BTS uses the first frame for data exchange with the MS in any process other than a process of performing access, authentication and resource allocation with the BTS for initial network entry.

14. The method of claim 13, wherein the first frame includes at least one of a preamble region for synchronization and channel estimation, a frame control header (FCH) region including an offset value, a MAP region including information on a location where data is allocated and a size thereof, a region where downlink data is allocated, a region where uplink data is allocated, and an access channel region that the MS or the relay BTS can randomly access.

15. The method of claim 14, wherein the offset value indicates in which frame following the current frame the first frame is to be used again.

16. The method of claim 14, wherein the FCH region includes frame type information indicating the first frame.

17. The method of claim 12, wherein the second frame includes at least one of a preamble region for synchronization and channel estimation, an FCH region including an offset value, a MAP region including information on a location where data is allocated and a size thereof, a region where downlink data is allocated, a region where uplink data is allocated, and a dedicated control channel region where a control signal exchanged between the relay BTS and the BTS through a dedicated channel.

18. The method of claim 17, wherein the offset value indicates in which frame following the current frame the second frame is to be used again.

19. The method of claim 17, wherein the FCH region includes frame type information indicating the second frame.

20. The method of claim 12, wherein the data exchanged between the BTS and the relay BTS has a relay header including type information indicating a type of exchanged information, an identifier of the relay BTS, and total data length information.

21. The method of claim 12, wherein the data exchanged between the BTS and the relay BTS has a medium access control (MAC) header including information used for distinguishing data of a plurality of MSs.
